(19) United States
(12) Patent Application Publication
(10) Pub. No.: US 2014/0320723 A1
(43) Pub. Date: Oct. 30, 2014

(54) CAMERA APPARATUS AND WIRELESS COMMUNICATION TERMINAL INCLUDING THE SAME

(71) Applicant: SAMSUNG ELECTRONICS CO., LTD., Suwon-si (KR)

(72) Inventor: Masahiro Shirono, Yokohama (JP)

(73) Assignee: SAMSUNG ELECTRONICS CO., LTD., Suwon-si (KR)

(21) Appl. No.: 14/259,371

(22) Filed: Apr. 23, 2014

(30) Foreign Application Priority Data
Apr. 24, 2013 (JP) 2013-091361
Jan. 8, 2014 (KR) 10-2014-0002494

(51) Int. Cl. H04N 5/232

(52) U.S. Cl. CPC H04N 5/23293
USPC 348/333.05

(57) ABSTRACT

Provided is a camera apparatus and a wireless communication terminal including the camera apparatus. The camera apparatus includes: a transparent rear monitor disposed on a back side of the camera apparatus; an electronic viewfinder disposed in front of the rear monitor and overlapping the rear monitor; and a control unit configured to control displaying of preview images on one of the rear monitor and the electronic viewfinder at a time. The control unit controls the rear monitor to display preview images at a first time when the rear monitor is used, and controls the electronic viewfinder to display preview images to transmit the preview images through the rear monitor at a different time when the rear monitor is not used.

### RELATED APPLICATIONS

This application claims the priority benefit of Japanese Patent Application No. 2013-0091361, filed on Apr. 24, 2013, in the Japanese Patent Office and Korean Patent Application No. 10-2014-0002494, filed on Jan. 8, 2014, in the Korean Intellectual Property Office, the disclosures of which are incorporated herein in their entireties by reference.

### BACKGROUND

1. Field

One or more embodiments relate to a camera apparatus and a wireless communication terminal including the camera apparatus.

2. Description of the Related Art

Cameras including viewfinders and rear displays have been developed. Cameras having viewfinders may be used in electronic apparatuses including wireless communication terminals, e.g., smartphones.

In a digital camera disclosed in Japanese Patent No. 4059229, an outwardly-protruding ridge is formed around a display region, a transparent or a cut-away portion is formed in a portion of the ridge, and a liquid crystal display panel equipped with a display driving device is disposed on another portion of the ridge. The liquid crystal display panel is mounted such that the display driving device is disposed beside an optical viewfinder unit and the transparent or cut-away portion is disposed on the optical viewfinder unit. Therefore, the display region may be enlarged to a region below the optical viewfinder unit, and thus, the digital camera may have a relatively large monitor screen.

Japanese Patent Application Publication No. H10-191114 discloses an electronic camera including a liquid crystal display monitor and an optical viewfinder, wherein a liquid crystal display unit including the liquid crystal display monitor is used as a switch. If the liquid crystal display unit is moved outward, the electronic camera enters an optical viewfinder mode, and the liquid crystal display monitor is turned off. Therefore, the body of the electronic camera may be reduced in size.

However, in the digital camera disclosed in Japanese Patent No. 4059229, the area of the display region may be smaller than the area of the rear side of the digital camera due to the area of the transparent or cut-away portion of the ridge. Particularly, since both the optical viewfinder unit and the display region are on the rear side of the digital camera, the rear side of the digital camera may lack unity in terms of appearance and may have a poor design.

The electronic camera disclosed in Japanese Patent Application Publication No. H10-191114 may have an increased thickness because of a structure for sliding the liquid crystal display monitor. In addition, due to a complex structure, the manufacturing cost of the electronic camera may be high and the structural reliability of the electronic camera may be low. In addition, since the liquid crystal display unit has a protruded structure for sliding the liquid crystal display monitor, the electronic camera may have an unaesthetic design.

Since wireless communication terminals such as smartphones are portable devices, the design of cameras included therein is important.

As described above, the cameras disclosed in Japanese Patent No. 4059229 and Japanese Patent Application Publication No. H10-191114 may have a poor design due to the use of the viewfinders.

### SUMMARY

One or more embodiments include a camera apparatus having an improved design in spite of a viewfinder included therein, and a wireless communication terminal or other electronic apparatus including the camera apparatus. The wireless communication terminal may include a smartphone, tablet personal computer, a portable gaming terminal, or a personal digital assistant.

Additional aspects will be set forth in part in the description which follows and, in part, will be apparent from the description, or may be learned by practice of the presented embodiments.

According to one or more embodiments, a camera apparatus includes: a transparent rear monitor disposed on a back side of the camera apparatus; an electronic viewfinder disposed in front of the rear monitor and overlapping the rear monitor; and a control unit configured to control displaying of preview images on one of the rear monitor and the electronic viewfinder at a time. The control unit controls the rear monitor to display preview images at a first time and controls the electronic viewfinder to display preview images to transmit the preview images through the rear monitor at a different time.

The electronic viewfinder may include a viewfinder window through which preview images are transmitted, an inner monitor configured to display the preview images, and a reflection member configured to reflect light coming from the preview images displayed on the inner monitor toward the viewfinder window.

A predetermined region of the rear monitor may include at least a region corresponding to the viewfinder window of the electronic viewfinder that has transmissivity greater than that of an other region of the rear monitor.

The camera apparatus may further include a proximity sensor configured to detect a user approaching the rear monitor within a predetermined range. If the proximity sensor detects that a user does not approach the rear monitor within the predetermined range, the control unit may switch the rear monitor to an operation mode and control the rear monitor to display the preview images. Alternatively, if the proximity sensor detects that a user approaches the rear monitor within the predetermined range, the control unit may switch the rear monitor to an idle mode and control the electronic viewfinder to display preview images to transmit the preview images through the rear monitor.

The camera apparatus may further include an input unit through which a command is input to switch the rear monitor between the operation mode and the idle mode, wherein the control unit switches the rear monitor between the operation mode and the idle mode according to a command input through the input unit.

A predetermined region formed between the electronic viewfinder and the rear monitor including at least a region corresponding to the viewfinder window of the electronic viewfinder may be a transparent region or an opening, and another region may include an opaque plate-shaped member.

The reflection member may include a mirror.

The reflection member may include a prism.

A wireless communication terminal may include the camera apparatus.

An electronic apparatus may include the camera apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1A is a rear view illustrating a wireless communication terminal according to an embodiment;

FIG. 1B is a front view illustrating the wireless communication terminal according to an embodiment;

FIG. 2 is a block diagram illustrating internal components of the wireless communication terminal according to an embodiment;

FIG. 3 is a cross-sectional view illustrating a camera apparatus of a wireless communication terminal according to an embodiment;

FIG. 4A is a cross-sectional view illustrating an exemplary case of using the organic EL panel in the wireless communication terminal according to an embodiment;

FIG. 4B is a cross-sectional view illustrating an exemplary case of not using the organic EL panel in the wireless communication terminal according to an embodiment;

FIG. 5A is a rear view illustrating exemplary images displayed on the camera apparatus of the wireless communication terminal when the organic EL panel is used according to an embodiment;

FIG. 5B is a rear view illustrating exemplary images displayed on the camera apparatus of the wireless communication terminal when the organic EL panel is not used according to an embodiment;

FIG. 6 is a rear view illustrating the structure of the organic EL panel of the wireless communication terminal according to another embodiment;

FIG. 7 is a cross-sectional view illustrating a first modification example of a camera apparatus of a wireless communication terminal according to an embodiment; and

FIG. 8 is a cross-sectional view illustrating a single-lens reflex camera according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

### Embodiment 1

Hereinafter, an exemplary embodiment will be described with reference to the accompanying drawings.

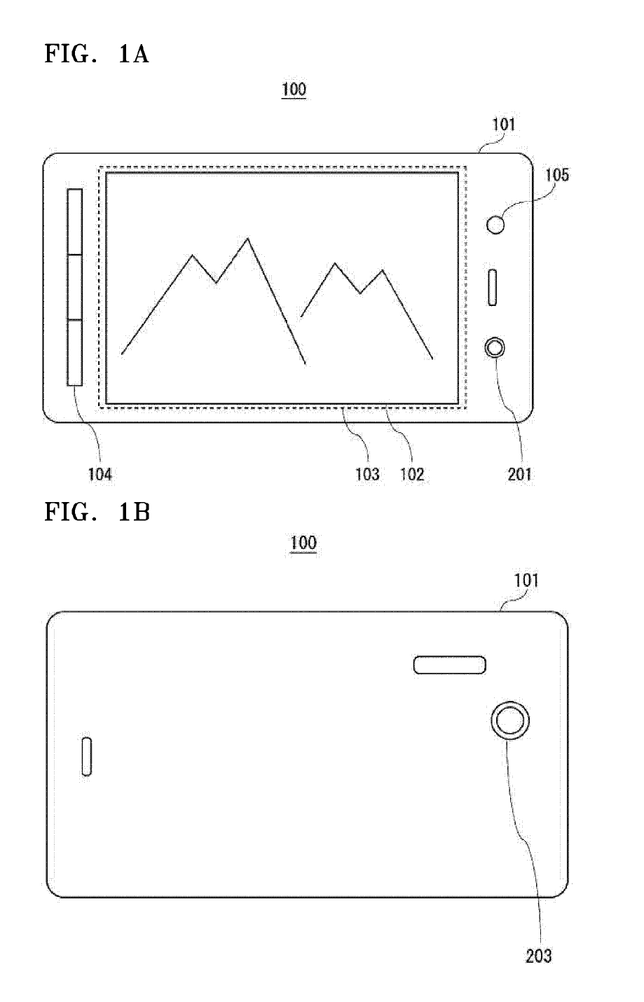

A wireless communication terminal 100 including a camera apparatus 200 will now be described according to an embodiment with reference to FIGS. 1A and 1B. FIGS. 1A and 1B are respectively a rear view and a front view illustrating the wireless communication terminal 100 according to an embodiment. Referring to FIGS. 1A and 1B, the wireless communication terminal 100 may be a smartphone. The wireless communication terminal 100 of the current embodiment may also be another type of wireless communication terminal, for example, a feature phone, a portable gaming terminal, a personal digital assistant (PDA), or a tablet personal computer (PC).

FIG. 1A is a view illustrating the wireless communication terminal 100, taken from a main side (rear side) of a housing 101 of the wireless communication terminal 100. An organic EL panel (e.g., organic electroluminescent display panel) 102, a touch panel 103 overlapped with the organic EL panel 102, a plurality of buttons 104, a proximity sensor 105, and a photographing lens 201 of the camera apparatus 200 (described later) are arranged on the rear side of the housing 101. The organic EL panel 102 may occupy almost all the region of the rear side of the housing 101.

FIG. 1B is a view illustrating the wireless communication terminal 100, taken from the other main side (front side) of the housing 101 of the wireless communication terminal 100. A photographing lens 203 of the camera apparatus 200 is disposed on the front side of the housing 101.

In the present embodiment, a main side facing an object to be photographed by the photographing lens 203 is referred to as “a front side,” and the other main side of the housing 101 is referred to as “a rear side.”

A screen of the organic EL panel 102 is disposed on the rear side of the housing 101. The organic EL panel 102 functions as a rear panel (e.g., rear monitor) of the wireless communication terminal 100 (including the camera apparatus 200). That is, when a user takes a picture of an object, the user may refer to a preview image displayed on the organic EL panel 102.

The organic EL panel 102 is a transmission type organic EL panel (e.g., transparent organic EL panel). That is, when the organic EL panel 102 is used (e.g., powered), images may be displayed on the organic EL panel 102, and when the organic EL panel 102 is not used (e.g., not powered), the inside of the housing 101 may be seen through the organic EL panel 102. The organic EL panel 102 may be transparent or translucent. However, the organic EL panel 102 may have high transmissivity (e.g., transparency). Instead of the organic EL panel 102, any other transparent display panel such as a liquid crystal display panel may be used.

The touch panel 103 may be disposed over the organic EL panel 102 to cover the screen of the organic EL panel 102 or may be disposed underneath the organic EL panel 102. For example, a user may intuitively operate the wireless communication terminal 100 by touching a touch region of the organic EL panel 102 with his/her finger or a manipulation pen (e.g., stylus).

The buttons 104 are used to subsidiarily manipulate the wireless communication terminal 100. In another embodiment, the buttons 104 may not be provided according to the type of the wireless communication terminal 100.

The proximity sensor 105 is a non-contact type sensor capable of sensing a target object approaching the wireless communication terminal 100. The proximity sensor 105 is used for sensing a user's face approaching the wireless communication terminal 100. The proximity sensor 105 may be at least one of an inductive sensor, a capacitive sensor, an ultrasonic sensor, an electromagnetic wave sensor, and an infrared sensor.

The photographing lens 203 is a main photographing lens disposed on the front side of the housing 101. The photographing lens 201 is a sub-photographing lens disposed on the rear side of the housing 101. In another embodiment, the sub-photographing lens 201 may not be provided.

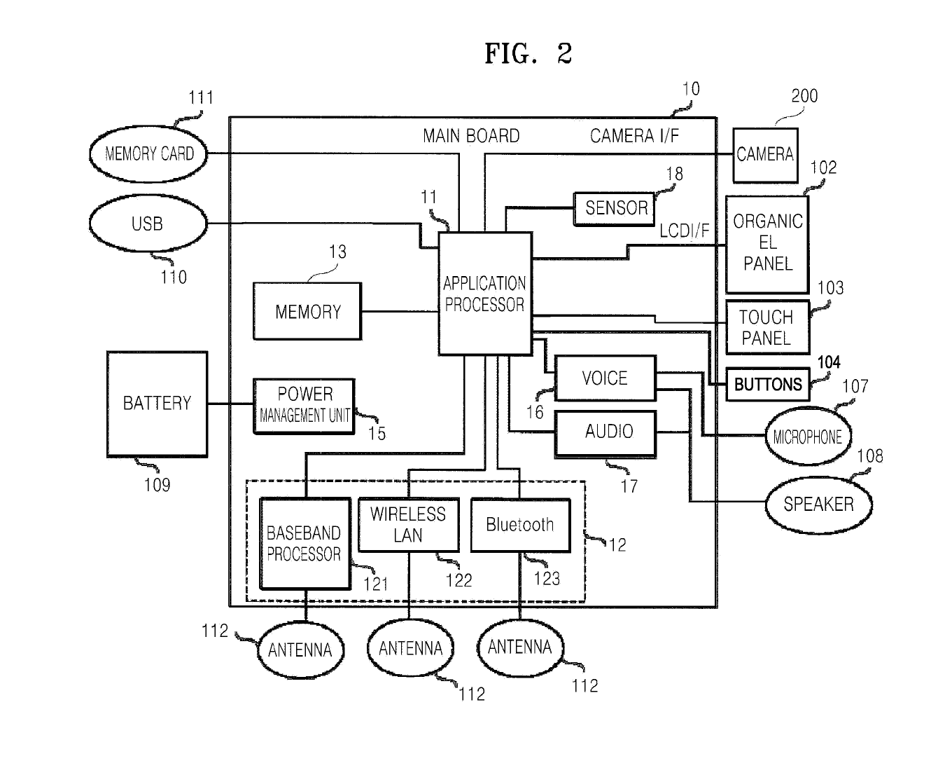

Next, an internal configuration of the wireless communication terminal 100 according to the present embodiment will be described with reference to FIG. 2. FIG. 2 is a block diagram illustrating internal components of the wireless communication terminal 100 according to an embodiment. Referring to FIG. 2, an application processor 11, a wireless processing unit 12, a memory 13, a power management unit 15, a voice circuit 16, an audio circuit 17, and a sensor 18 may be disposed on a main board 10 of the wireless communication terminal 100. The organic EL panel 102, the touch panel 103, the buttons 104, and the camera apparatus 200 may be connected to the main board 10. In addition, a microphone 107, a speaker 108, a battery 109, a Universal Serial Bus (USB) 110, a memory card 111, and an antenna 112 may be connected to the main board 10.

In general, the application processor 11 is a system on a chip (SoC) device in which various peripheral circuits are packaged. The application processor 11 includes various interface circuits for connecting peripheral devices such as a communication device (for example, the wireless processing unit 12), the touch panel 103, and the camera apparatus 200.

The application processor 11 reads programs stored in the memory 13 and executes various functions of the wireless communication terminal 100. For example, the application processor 11 reads an operating system (OS) program from the memory 13 to execute the OS program, and along with this, the application processor 11 executes application programs running based on the OS program. The application processor 11 performs various processing processes according to programs running thereon.

The wireless processing unit 12 includes a baseband processor 121, a wireless LAN 122, and a BLUETOOTH® device 123. The baseband processor 121 performs baseband processing such as encoding (e.g., error-correcting encoding using a convolution code or a turbo code) of data to be transmitted through the wireless communication terminal 100 or decoding of data received through the wireless communication terminal 100. In detail, the baseband processor 121 may encode transmission data received from the application processor 11 and modulate the transmission data using carrier waves to generate a transmission signal. The transmission signal may be transmitted through the antenna 112. In addition, the baseband processor 121 may demodulate a signal received through the antenna 112 by extracting data from carrier waves and may decode the data to transmit the decoded data to the application processor 11.

Programs and data for the application processor 11 are stored in the memory 13. The memory 13 may include one or more of a nonvolatile memory (e.g., a flash memory) capable of retaining stored data even when not powered, and a volatile memory not retaining data when not powered.

The battery 109 is used when the wireless communication terminal 100 is operated without being powered from an external power source. In addition, the wireless communication terminal 100 may be powered from the battery 109 even when being connected to an external power source. The battery 109 may be a secondary battery.

The power management unit 15 may generate internal power from the battery 109 or an external power source. The internal power is supplied to each block of the wireless communication terminal 100. The power management unit 15 may control internal power supplied to each block under the control of the application processor 11. In addition, when an external power source is connected to the wireless communication terminal 100, the power management unit 15 may control charging of the battery 109.

The audio circuit 17 decodes voice data received from the application processor 11 to operate the speaker 108. The voice circuit 16 encodes voice information obtained from the microphone 107 to generate voice data to be sent to the application processor 11.

The sensor 18 may include one or more of a temperature sensor and a global positioning system (GPS) sensor. When the battery 109 is charged, the temperature of the battery 109 may be controlled using the temperature sensor. Owing to the GPS, the position of the wireless communication terminal 100 may be precisely determined, and thus the wireless communication terminal 100 may be used as a navigation device for finding a destination. In addition, the GPS sensor of the wireless communication terminal 100 may include a function (e.g., assisted GPS: A-GPS) for detecting positions more rapidly through assistant communication.

The organic EL panel 102 displays various images according to operations of the application processor 11. The organic EL panel 102 displays images such as user interface images used when a user inputs an instruction to the wireless communication terminal 100, still images, and videos. The still images include images taken using a photographing function of the wireless communication terminal 100, and the videos include a preview video of an object displayed for the purpose of helping the perception of the object during photographing.

The camera apparatus 200 is used to capture images according to photographing timing and instructions issued by the application processor 11. The camera apparatus 200 stores the captured images in the memory card 111. The photographing timing may be a time point when a user inputs a photographing command using the touch panel 103 or the buttons 104. That is, the application processor 11 instructs the camera apparatus 200 to capture an image in response to a photographing command, and receives the captured image from the camera apparatus 200.

<Exemplary Configuration of Camera Apparatus 200 in Embodiment 1>

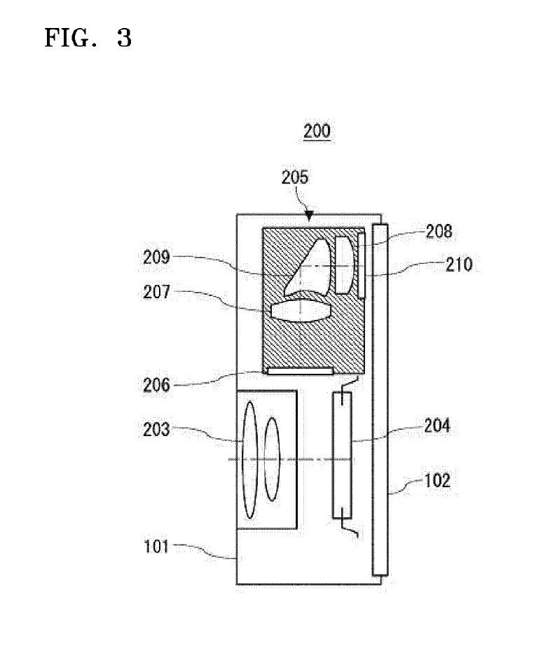

A camera apparatus 200 of an embodiment will now be described in detail with reference to FIG. 3. FIG. 3 is a cross-sectional view illustrating a camera apparatus 200 of a wireless communication terminal 100 according to an embodiment. In the following description it is assumed that the camera apparatus 200 includes the photographing lens 203 but does not includes the photographing lens 201.

Referring to FIG. 3, the camera apparatus 200 includes the photographing lens 203, an image sensor 204, the organic EL panel 102, and an electronic viewfinder unit 205. The housing 101 of the wireless communication terminal 100 is a main body of the camera apparatus 200. That is, although the camera apparatus 200 is schematically illustrated in FIG. 2 as being disposed in the housing 101 of the wireless communication terminal 100, the housing 101 of the wireless communication terminal 100 may be the main body of the camera apparatus 200.

The electronic viewfinder unit 205 includes a liquid crystal display panel (e.g., inner monitor) 206, an object lens 207, an ocular 208, a mirror (e.g., reflection member) 209, and a viewfinder window 210. The number of lenses of the electronic viewfinder unit 205 is not limited to the number of lenses shown in FIG. 3. That is, the number of lenses of the electronic viewfinder unit 205 may vary.

Light reflected from an object passes through the photographing lens(es) 203 and enters the camera apparatus 200 as an optical signal. The image sensor 204 converts the optical signal received from the photographing lens 203 into an electric signal (that is, the image sensor 204 forms an image of the object). The result (e.g., image) of conversion by the image sensor 204 is displayed on the organic EL panel 102 or the liquid crystal display panel 206.

When the organic EL panel 102 is used (that is, when the electronic viewfinder unit 205 is not used), images are displayed on the organic EL panel 102 disposed on the rear side of the housing 101, but no image is displayed on the liquid crystal display panel 206 of the electronic viewfinder unit 205. That is, when the organic EL panel 102 is used, a user may see a preview image displayed on the organic EL panel 102 disposed on the rear side of the camera apparatus 200.

On the other hand, when the organic EL panel 102 is not used (that is, when the electronic viewfinder unit 205 is used), images are displayed on the liquid crystal display panel 206 of the electronic viewfinder unit 205, but no image is displayed on the organic EL panel 102 disposed on the rear side of the housing 101. That is, when the organic EL panel 102 is not used, a user may see a preview image displayed on the liquid crystal display panel 206 of the electronic viewfinder unit 205 disposed inside the camera apparatus 200 through the transparent organic EL panel 102 disposed on the rear side of the camera apparatus 200.

For example, the electronic viewfinder unit 205 has a polygonal pillar shape. The liquid crystal display panel 206 may be disposed in the electronic viewfinder unit 205. In detail, the liquid crystal display panel 206 may be disposed at a position close to the bottom of the electronic viewfinder unit 205 (e.g., a lower side on the plane of FIG. 3). That is, the liquid crystal display panel 206 may be disposed on the bottom of the electronic viewfinder unit 205 or may be disposed at a position higher than the bottom of the electronic viewfinder unit 205 by a predetermined length. A screen of the liquid crystal display panel 206 faces toward an upper side of the electronic viewfinder unit 205 (e.g., in an upward direction on the plane of FIG. 3). Instead of the liquid crystal display panel 206, a different kind of display panel such as an organic EL panel or a plasma display panel may be disposed in the electronic viewfinder unit 205.

The object lens 207 may be disposed at a position higher than the bottom of the electronic viewfinder unit 205 (a lower side on the plane of FIG. 3) by a predetermined length. That is, the object lens 207 may be spaced apart from the liquid crystal display panel 206 by a predetermined length in the upward direction. In this structure, light from an image displayed on the liquid crystal display panel 206 may reach the mirror 209 through the object lens 207. In addition, the object lens 207 is disposed such that the optical axis of the object lens 207 is aligned with the upward direction of the electronic viewfinder unit 205 (e.g., upward direction on the plane of FIG. 3). That is, the optical axis of the object lens 207 is perpendicular to the screen of the liquid crystal display panel 206.

The mirror 209 is disposed at an exit side of the object lens 207. The mirror 209 reflects light passing through the object lens 207 toward the ocular 208. A prism may be used as a reflection member instead of the mirror 209. If a prism is used, effects similar to those created by a lens may be obtained in addition to a reflecting effect. In this case, for example, optical elements such as the ocular 208 may not be used, and thus, the thickness of the camera apparatus 200 may be reduced. However, if only the reflecting effects of a prism and the mirror 209 are compared, the mirror 209 may be used to reduce costs.

The ocular 208 is disposed at a position close to a side of the electronic viewfinder unit 205 (e.g., the right side on the plane of FIG. 3, the rear side of the housing 101). That is, the ocular 208 is spaced apart from the viewfinder window 210 by a predetermined length in a forward direction (e.g., in the left direction on the plane of FIG. 3). In addition, the optical axis of the object lens 208 is parallel with a direction different from the upward direction of the electronic viewfinder unit 205. Referring to FIG. 3, the optical axis of the ocular 208 is parallel with the thickness direction of the housing 101 (e.g., the horizontal or left-to-right direction on the plane of FIG. 3). That is, the ocular 208 is disposed such that the optical axis of the ocular 208 is perpendicular to the optical axis of the object lens 207. In this case, the mirror 209 reflects light received from the object lens 207 at a right angle toward the ocular 208. In addition, the optical axis of the object lens 208 is perpendicular to the plane of the viewfinder window 210.

The viewfinder window 210 is disposed at a side of the electronic viewfinder unit 205 (e.g., the right side on the plane of FIG. 3; the rear side of the housing 101). In the embodiment shown in FIG. 3, the viewfinder window 210 is parallel with the transparent organic EL panel 102.

The mirror 209 reflects light passing through the object lens 207 toward the ocular 208, and thus, an optical path having a sufficient length may be formed along the screen of the liquid crystal display panel 206, the object lens 207, the mirror 209, the ocular 208, and the viewfinder window 210. That is, although the liquid crystal display panel 206, the object lens 207, the mirror 209, and the ocular 208 are not arranged in a line, an optical path having a sufficient length may be formed. Therefore, the camera apparatus 200 may have a small thickness in a front-to-rear direction (e.g., the horizontal direction on the plane of FIG. 3). This is useful for including the camera apparatus 200 in the wireless communication terminal 100 having a small thickness according to the recent trend.

The object lens 207 receives light from an image displayed on the liquid crystal display panel 206 and condenses the light onto a focus thereof to form a real image. The real image is reflected to the ocular 208 by the mirror 209. The real image formed by the object lens 207 and reflected by the mirror 209 is enlarged by the ocular 208. The real image (e.g., preview image) enlarged by the ocular 208 may be seen on the viewfinder window 210. In this way, the sense of distance to an object to be photographed may be provided like in the case of using an optical viewfinder.

During photographing, the camera apparatus 200 in the wireless communication terminal 100 having the above-described structure is operated as follows. If the organic EL panel 102 is used, the liquid crystal display panel 206 of the electronic viewfinder unit 205 is turned off so as not to display a preview image thereon, and the organic EL panel 102 disposed on the rear side of the camera apparatus 200 is turned on to display a preview image. That is, when the organic EL panel 102 is used, a user may see a preview image displayed on the organic EL panel 102 disposed on the rear side of the camera apparatus 200.

If the organic EL panel 102 is not used, the organic EL panel 102 disposed on the rear side of the camera apparatus 200 is turned off so as not to display a preview image thereon, and the liquid crystal display panel 206 of the electronic viewfinder unit 205 is turned on to display a preview image. That is, when the organic EL panel 102 is not used, a user may see a preview image displayed on the liquid crystal display panel 206 of the electronic viewfinder unit 205 disposed inside the camera apparatus 200 through the organic EL panel 102 disposed on the rear side of the camera apparatus 200.

According to the above-described structure, although the camera apparatus 200 in the wireless communication terminal 100 is used for photographing using an electronic viewfinder (e.g., the electronic viewfinder unit 205) and a rear monitor (e.g., the organic EL panel 102) as well, the camera apparatus 200 may have a simple design because the electronic viewfinder is disposed in the camera apparatus 200 in front of the rear monitor and the rear side of the camera apparatus 200 is covered with the rear monitor. Therefore, the design of the camera apparatus 200 in the wireless communication terminal 100 may be improved.

<Exemplary Operations of Camera Apparatus 200 in Embodiment 1>

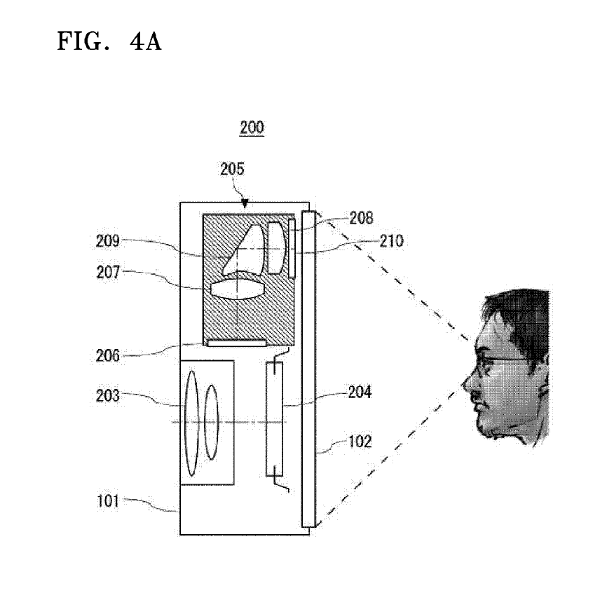

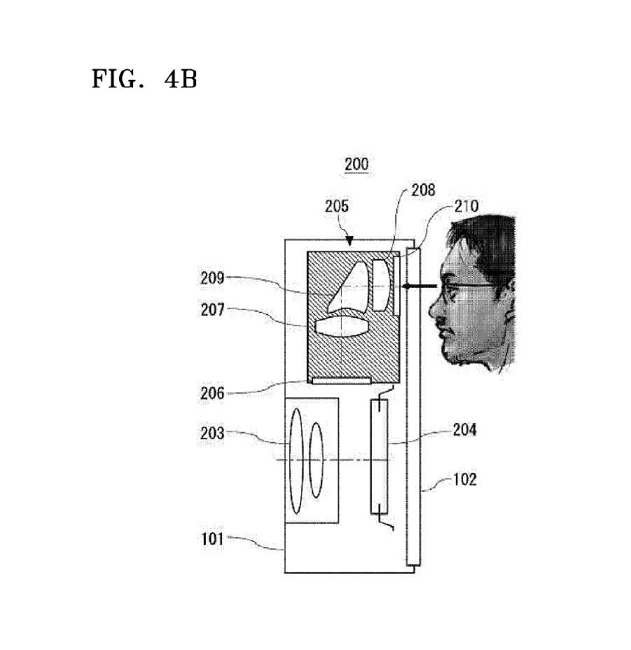

Next, exemplary operations of the camera apparatus 200 will be described according to the embodiment with reference to the accompanying drawings. FIGS. 4A and 4B are cross-sectional views for explaining exemplary operations of the camera apparatus 200 according to an embodiment. FIGS. 5A and 5B are rear views illustrating exemplary images displayed on the camera apparatus 200 according to an embodiment.

FIG. 4A is a cross-sectional view illustrating an exemplary case of using the organic EL panel 102 in the wireless communication terminal 100 according to an embodiment, and FIG. 4B is a cross-sectional view illustrating an exemplary case of not using the organic EL panel 102 in the wireless communication terminal 100 according to an embodiment. FIG. 5A is a rear view illustrating exemplary images displayed on the camera apparatus 200 of the wireless communication terminal 100 when the organic EL panel 102 is used according to an embodiment, and FIG. 5B is a rear view illustrating exemplary images displayed on the camera apparatus 200 of the wireless communication terminal 100 when the organic EL panel 102 is not used according to an embodiment.

As shown in FIG. 4A, if a user's face does not approach the proximity sensor 105 within an object-detection range of the proximity sensor 105, the proximity sensor 105 transmits a non-detection notice signal to the application processor 11.

In response to the non-detection notice signal from the proximity sensor 105, the application processor 11 turns on the organic EL panel 102 disposed on the rear side of the camera apparatus 200 and displays preview images formed by the image sensor 204 on the organic EL panel 102. At this time, the application processor 11 turns off the liquid crystal display panel 206 of the electronic viewfinder unit 205, and thus the preview images formed by the image sensor 204 are not displayed on the liquid crystal display panel 206.

In this way, when a user moves his/her face away from the camera apparatus 200 so as to observe an object to be photographed through the organic EL panel 102 disposed on the rear side of the camera apparatus 200 as shown in FIG. 4A, preview images are displayed on the organic EL panel 102 as shown in FIG. 5A. That is, a user may check an object to be photographed by seeing preview images displayed on the rear panel (e.g., the organic EL panel 102).

On the other hand, as shown in FIG. 4B, if a user's face approaches the proximity sensor 105 within an object-detection range of the proximity sensor 105, the proximity sensor 105 detects the user's face and transmits a detection notice signal to the application processor 11.

In response to the detection notice signal from the proximity sensor 105, the application processor 11 turns on the liquid crystal display panel 206 of the electronic viewfinder unit 205 and displays preview images formed by the image sensor 204 on the liquid crystal display panel 206. At this time, the application processor 11 turns off the organic EL panel 102 disposed on the rear side of the camera apparatus 200, and thus the preview images formed by the image sensor 204 are not displayed on the organic EL panel 102.

In this way, when a user moves his/her face close to the camera apparatus 200 so as to observe an object to be photographed through the liquid crystal display panel 206 of the electronic viewfinder unit 205 as shown in FIG. 4B, preview images are displayed on the liquid crystal display panel 206 as shown in FIG. 5B. That is, a user may check an object to be photographed by seeing preview images displayed on the electronic viewfinder (e.g., the liquid crystal display panel 206 of the electronic viewfinder) through the rear panel (e.g., the organic EL panel 102).

In the camera apparatus 200, a predetermined region formed between the organic EL panel 102 and the electronic viewfinder unit 205 and including at least a region corresponding to the viewfinder window 210 of the electronic viewfinder unit 205 may be a transparent region or an opening, and the other region may include a plate-shaped opaque member. Then, images displayed on the liquid crystal display panel 206 may be seen through the viewfinder window 210 but the inside of the camera apparatus 200 may not be seen through a region other than the viewfinder window 210.

The plate-shaped opaque member may have a transparent portion or opening in a region corresponding to the viewfinder window 210, and the size of the region may be equal to or larger than the viewfinder window 210 by several percent. In this way, the inside of the camera apparatus 200 may be seen less.

As described with reference to the present embodiment, the rear monitor (e.g., the organic EL panel 102) is transparent, and the electronic viewfinder (e.g., the electronic viewfinder unit 205) is disposed in front of the rear monitor and overlapped with the rear monitor. When the rear monitor is used, preview images are displayed on the rear monitor so that a user may see the preview images, and when the rear monitor is not used, preview images are displayed on the electronic viewfinder, so that a user may see the preview images displayed on the electronic viewfinder through the rear monitor.

Therefore, since the electronic viewfinder is disposed inside the camera apparatus 200 in a region covered with the rear panel, the camera apparatus 200 may have a polished design by covering the entire rear side of the camera apparatus 200 with a single panel. That is, the camera apparatus 200 may be variously designed.

In addition, since the rear panel is fixed, the camera apparatus 200 may have a smaller thickness as compared with camera apparatuses having moving mechanisms for rear panels. Furthermore, since the camera apparatus 200 does not have a mechanism for moving the rear panel, the manufacturing cost of the camera apparatus 200 may be reduced, and the structural reliability of the camera apparatus 200 may be improved.

### Embodiment 2

Next, a camera apparatus and a wireless communication terminal including the same will be described according to another embodiment. However, descriptions of those structures and operations of the wireless communication terminal and the camera apparatus of this embodiment that are the same as those of the wireless communication terminal 100 and the camera apparatus 200 of the previous embodiment described with reference to FIGS. 1A to 5B will not be repeated.

In the current embodiment, the material of an organic EL panel 102 will be described in more detail.

In general, a transmission type organic EL panel (e.g., transparent organic EL panel) displays darker images as the transmissivity (e.g., transparency) of the organic EL panel increases. That is, a transmission type organic EL panel having a relatively higher transmissivity requires more intensive (e.g., brighter) light emission than a transmission type organic EL panel having a relatively lower transmissivity, for having the same brightness as that of the transmission type organic EL panel having a relatively lower transmissivity. Thus, a transmission type organic EL panel having a relatively higher transmissivity consumes more power than a transmission type organic EL panel having a relatively lower transmissivity. Therefore, in the current embodiment, the organic EL panel 102 may be formed of materials described below so as to reduce power consumption thereof.

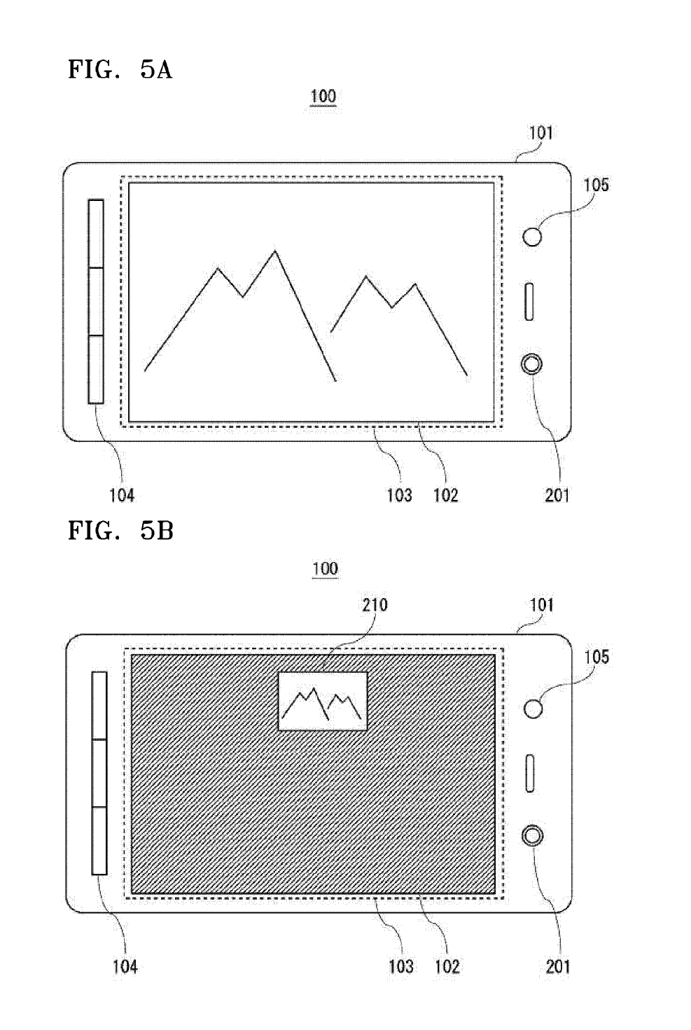

The structure of the organic EL panel 102 will now be described with reference to FIG. 6. FIG. 6 is a rear view illustrating the structure of the organic EL panel 102 of the wireless communication terminal 100 according to another embodiment.

In the current embodiment, the transmissivity of the organic EL panel 102 is at least different in a first region 300 including a region corresponding to a viewfinder window 210 and a second region 301 other than the first region 300.

In detail, the first region 300 of the organic EL panel 102 is formed of a material having a higher transmissivity than a material used to form the second region 301 of the organic EL panel 102, so that a user may easily see images displayed on a viewfinder window 210 through the first region 300. The second region 301 may be formed of an opaque material.

In this case, the light emission intensity of the second region 301 not including a region corresponding to the viewfinder window 210 may be set to be lower than that of the first region 300, for example to reduce power consumption. In addition, since the first region 300 including a region corresponding to the viewfinder window 210 has a high level of transmissivity, a user may easily see images displayed on a liquid crystal display panel 206 of an electronic viewfinder unit 205 through the first region 300.

The first region 300 having a high level of transmissivity may include a region corresponding to the viewfinder window 210 or may be larger than the region corresponding to the viewfinder window 210 by several percent. In this way, the area of the second region 301 having a low level of transmissivity and consuming less power may be increased to reduce power consumption.

As described above, in the current embodiment, a predetermined region of a rear monitor including a region corresponding to the viewfinder window 210 of an electronic viewfinder (e.g., the electronic viewfinder unit 205) is set to have a higher level of transmissivity than the other region. Therefore, although the light emission intensity of the other region of the rear monitor is set to be relatively low, the other region may have the same brightness level as the predetermined region. Therefore, power consumption may be reduced by lowering the light emission intensity of the region other than the predetermined region.

### First Modification Example

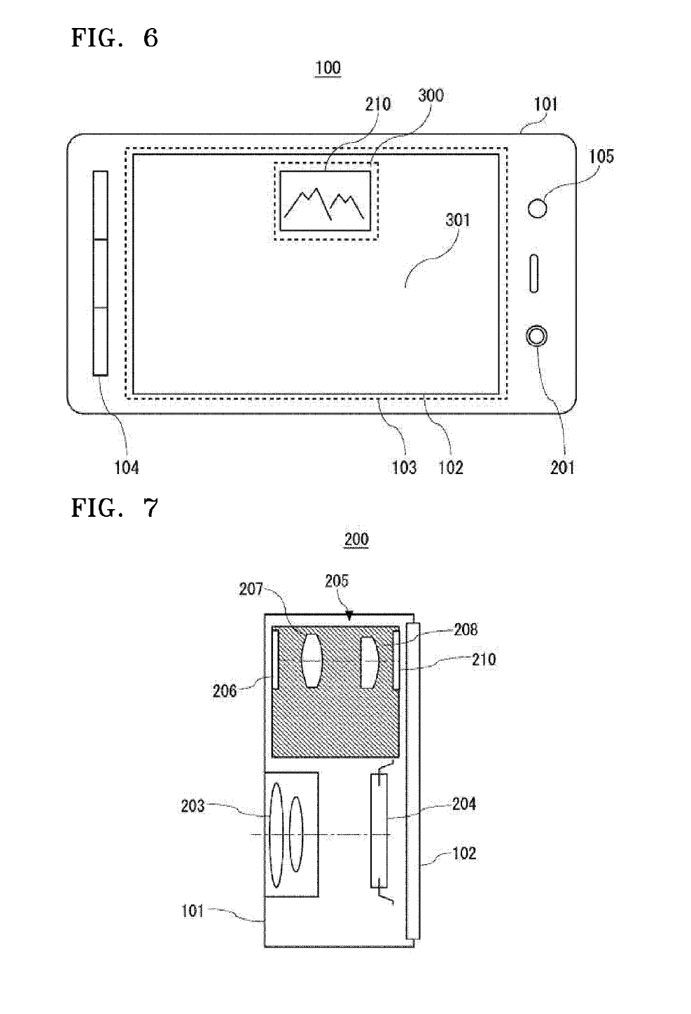

Next, a first modification example of the camera apparatus 200 will now be described according to an embodiment with reference to FIG. 7. FIG. 7 is a cross-sectional view illustrating the first modification example of the camera apparatus 200 of the wireless communication terminal 100 according to an embodiment. The above-described embodiments may be modified by changing the structure of the electronic viewfinder unit 205 as described below.

Referring to FIG. 7, a liquid crystal display panel 206, an object lens 207, an ocular 208, and a viewfinder window 210 of an electronic viewfinder unit 205 are linearly arranged in a front-to-rear direction of a camera apparatus 200. As shown in FIG. 7, a mirror 209 may not be used.

In the first modification example, the liquid crystal display panel 206 is disposed at a position close to a side of the electronic viewfinder unit 205 (e.g., the left side on the plane of FIG. 7, the front side of a housing 101). That is, the liquid crystal display panel 206 may be disposed on the front side of the electronic viewfinder unit 205 or may be disposed at a position spaced apart from the front side of the electronic viewfinder unit 205 by a predetermined length in a backward direction (e.g., the right direction or rear direction on the plane of FIG. 7). A screen of the liquid crystal display panel 206 faces toward the rear side of the electronic viewfinder unit 205 (e.g., the right side or back side on the plane of FIG. 7).

In addition, the object lens 207 is disposed at a position close to a side of the electronic viewfinder unit 205 (e.g., the left side on the plane of FIG. 7, the front side of the housing 101). That is, the object lens 207 is spaced apart from the liquid crystal display panel 206 by a predetermined length in the backward direction. In this structure, light from an image displayed on the liquid crystal display panel 206 is incident on the ocular 208 after passing through the object lens 207. The optical axis of the object lens 207 is parallel with the thickness direction of the housing 101 (e.g., the horizontal, or left-to-right, direction on the plane of FIG. 7). That is, the optical axis of the object lens 207 is perpendicular to the screen of the liquid crystal display panel 206. In addition, the optical axis of the ocular 208 is aligned with the optical axis of the object lens 207.

The distance between the liquid crystal display panel 206 and the viewfinder window 210 is set so that an optical path formed along the screen of the liquid crystal display panel 206, the object lens 207, the ocular 208, and the viewfinder window 210 has an adequate length.

In the above-described structure, the electronic viewfinder unit 205 is disposed inside the camera apparatus 200, and the rear side of the camera apparatus 200 is almost fully covered by an organic EL panel 102. Therefore, the camera apparatus 200 of the wireless communication terminal 100 may have a simple and improved design.

However, as described above, even when a mirror 209 is not used, a necessary optical path length may be ensured without increasing the thickness (e.g., front-to-back width) of the camera apparatus 200, and thus the design of the camera apparatus 200 may be further improved while reducing the thickness of the camera apparatus 200.

### Second Modification Example

In the above-described embodiments, the use of the organic EL panel 102 for displaying preview images and the use of the liquid crystal display panel 206 for displaying preview images are switched according to detection results of the proximity sensor 105. However, the embodiments are not limited thereto.

For example, switching between use of the organic EL panel 102 and the liquid crystal display panel 206 may be performed by a user by manipulating a switching button (e.g., input unit). In this case, a button of the wireless communication terminal 100 may be used as a switching button. For example, one of the buttons 104 may be used as a switching button, or a button formed on the organic EL panel 102 or the touch panel 103 may be used as a switching button.

In this case, if a user manipulates a switching button, the buttons 104 or the touch panel 103 may transmit a switching signal to the application processor 11. According to the switching signal from the buttons 104 or the touch panel 103, the application processor 11 may switch the organic EL panel 102 between an operation-display mode and an idle-display mode.

In this manner, a user may perform switching to see preview images on the rear monitor (e.g., the organic EL panel 102) or the electronic viewfinder (e.g., the electronic viewfinder unit 205) without having to be close to the camera apparatus 200.

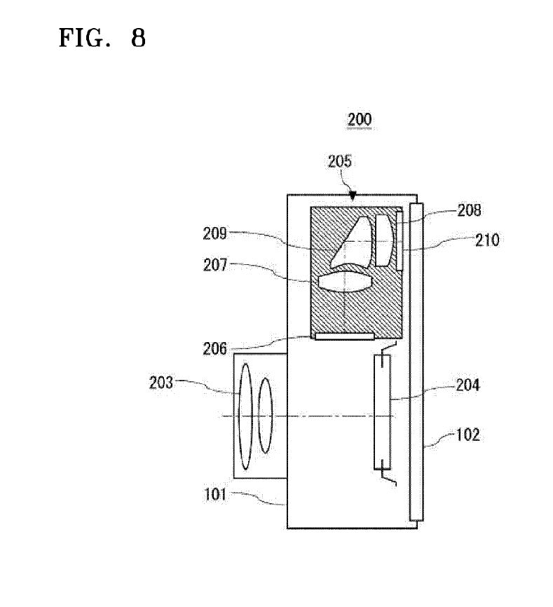

The embodiments are not limited to the above description, and may be modified. For example, although the wireless communication terminal 100 is described in the embodiments, a digital single-lens reflex camera (particularly, a mirrorless type) such as that shown in FIG. 8 may be employed as a camera apparatus 200 according to an embodiment. FIG. 8 is a cross-sectional view illustrating a single-lens reflex camera according to an embodiment. Generally, as shown in FIG. 8, a lens group including a photographing lens 203 protrudes from a main body of a digital single-lens reflex camera. However, the rear side of the digital single-lens reflex camera including a rear monitor (e.g., organic EL panel 102) is simple, and thus, the digital single-lens reflex camera may have an improved design according to the embodiments.

As described above, according to the one or more embodiments, the design of the camera apparatus may be improved although the camera apparatus includes a viewfinder, and the wireless communication terminal including the camera apparatus may be provided.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Descriptions of features or aspects within each embodiment should typically be considered as available for other similar features or aspects in other embodiments unless stated otherwise. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a computer-readable media such as non-transitory magnetic storage media (e.g., magnetic tapes, hard disks, floppy disks), non-transitory optical recording media (e.g., CD-ROMs, Digital Versatile Discs (DVDs), etc.), and non-transitory solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A camera apparatus comprising:
a transparent rear monitor;
an electronic viewfinder disposed in front of the rear monitor and overlapping the rear monitor; and
a control unit configured to control displaying of preview images on one of the rear monitor and the electronic viewfinder at a time,
wherein the control unit controls the rear monitor to display preview images at a first time and controls the electronic viewfinder to display preview images to transmit the preview images through the rear monitor at a different time.

2. The camera apparatus of claim 1, wherein the electronic viewfinder comprises:
a viewfinder window through which preview images are transmitted;
an inner monitor configured to display the preview images; and
a reflection member configured to reflect light coming from the preview images displayed on the inner monitor toward the viewfinder window.

3. The camera apparatus of claim 2, wherein a predetermined region of the rear monitor comprising at least a region corresponding to the viewfinder window of the electronic viewfinder has transmissivity greater than that of an other region of the rear monitor.

4. The camera apparatus of claim 1, further comprising a proximity sensor configured to detect a user approaching the rear monitor within a predetermined range,
wherein, if the proximity sensor detects that a user does not approach the rear monitor within the predetermined range, the control unit switches the rear monitor to an operation mode and controls the rear monitor to display the preview images, and if the proximity sensor detects that a user approaches the rear monitor within the predetermined range, the control unit switches the rear monitor to an idle mode and controls the electronic viewfinder to display preview images to transmit the preview images through the rear monitor.

5. The camera apparatus of claim 4, further comprising an input unit through which a command is input to switch the rear monitor between the operation mode and the idle mode,
wherein the control unit switches the rear monitor between the operation mode and the idle mode according to a command input through the input unit.

6. The camera apparatus of claim 2, wherein a predetermined region formed between the electronic viewfinder and the rear monitor and comprising at least a region corresponding to the viewfinder window of the electronic viewfinder is a transparent region or an opening, and another region comprises an opaque plate-shaped member.

7. The camera apparatus of claim 2, wherein the reflection member includes a mirror.

8. The camera apparatus of claim 2, wherein the reflection member includes a prism.

9. A wireless communication terminal comprising the camera apparatus of claim 1.

10. An electronic apparatus comprising the camera apparatus of claim 1.
